(19) United States
(12) Patent Application Publication
(10) Pub. No.: US 2024/0249125 A1
(43) Pub. Date: Jul. 25, 2024

(54) LEARNING LATENT-SPACE BARRIER FUNCTIONS FROM SAFE DEMONSTRATIONS

(71) Applicant: TOYOTA RESEARCH INSTITUTE, INC., Los Altos, CA (US)

(72) Inventors: Fernando CASTANEDA GARCIA-ROZAS, Berkeley, CA (US); Haruki NISHIMURA, Sunnydale, CA (US); Rowan MCALLISTER, San Jose, CA (US); Adrien David GAIDON, Mountain View, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/481,164

(22) Filed: Oct. 4, 2023

Related U.S. Application Data
(60) Provisional application No. 63/440,222, filed on Jan. 20, 2023.

(51) Int. Cl. G06N 3/048

(52) U.S. Cl. CPC G06N 3/048

(57) ABSTRACT

A method for a task-agnostic policy filter control system is described. The method includes encoding a current observation, a previous latent state, and a previous action to output a new latent state. The method also includes computing, by a neural ordinary differential equations (ODE) module, learned latent state-space dynamic models for the new latent state. The method further includes inferring, by an in-distribution barrier function (iDBF) model, an iDBF value in response to the new latent state. The method also includes computing, based on the learned latent state-space dynamic models, the iDBF value and a reference control input for a current timestep, and a current action. The current action keeps the task-agnostic policy filter control system in-distribution with respect to an offline-collected dataset of safe demonstrations.

### CROSS-REFERENCE TO RELATED APPLICATION

The present application claims be benefit of U.S. Provisional Patent Application No. 63/440,222, filed Jan. 20, 2023, and titled “LEARNING LATENT-SPACE BARRIER FUNCTIONS FROM SAFE DEMONSTRATIONS,” the disclosure of which is expressly incorporated by reference herein in its entirety.

### BACKGROUND

### Field

Certain aspects of the present disclosure relate to autonomous vehicle technology and, more particularly, to learning latent-space barrier functions from safe demonstration.

### Background

Autonomous agents (e.g., vehicles, robots, etc.) rely on machine vision for sensing a surrounding environment by analyzing areas of interest in a scene from images of the surrounding environment. Autonomous agents, such as driverless cars and robots, are quickly evolving and have become a reality in this decade. For example, distinct levels of autonomous vehicles may provide a safety system that improves driving of a vehicle. For example, in a Level 5 vehicle, the set of advanced driver assistance system (ADAS) features installed in a vehicle provide complete vehicle control.

Learning-based control approaches have shown great promise in performing complex tasks directly from high-dimensional perception data for real autonomous agent systems. Nonetheless, the learned controllers can behave unexpectedly if the trajectories of the system divert from the training data distribution, which can compromise safety. A control filter that wraps any reference policy and effectively encourages the system to stay in-distribution with respect to offline-collected safe demonstrations is desired.

### SUMMARY

A method for a task-agnostic policy filter control system is described. The method includes encoding a current observation, a previous latent state, and a previous action to output a new latent state. The method also includes computing, by a neural ordinary differential equations (ODE) module, learned latent state-space dynamic models for the new latent state. The method further includes inferring, by an in-distribution barrier function (iDBF) model, an iDBF value in response to the new latent state. The method also includes computing, based on the learned latent state-space dynamic models, the iDBF value and a reference control input for a current timestep, and a current action. The current action keeps the task-agnostic policy filter control system in-distribution with respect to an offline-collected dataset of safe demonstrations.

A non-transitory computer-readable medium having program code recorded thereon for a task-agnostic policy filter control system is described. The program code is executed by a processor. The non-transitory computer-readable medium includes program code to encode a current observation, a previous latent state, and a previous action to output a new latent state. The non-transitory computer-readable medium also includes program code to compute, by a neural ordinary differential equations (ODE) module, learned latent state-space dynamic models for the new latent state. The non-transitory computer-readable medium further includes program code to infer, by an in-distribution barrier function (iDBF) model, an iDBF value in response to the new latent state. The non-transitory computer-readable medium also includes program code to compute, based on the learned latent state-space dynamic models, the iDBF value and a reference control input for a current timestep, and a current action. The current action keeps the task-agnostic policy filter control system in-distribution with respect to an offline-collected dataset of safe demonstrations.

A task-agnostic policy filter control system is described. The system includes a recursive encoder module to encode a current observation, a previous latent state, and a previous action to output a new latent state. The system also includes a neural ordinary differential equations (ODE) module to compute learned latent state-space dynamic models for the new latent state. The system further includes an in-distribution barrier function (iDBF) model to infer an iDBF value in response to the new latent state. The system also includes an agent action selection module to compute, based on the learned latent state-space dynamic models, the iDBF value and a reference control input for a current timestep, and a current action. The current action keeps the task-agnostic policy filter control system in-distribution with respect to an offline-collected dataset of safe demonstrations.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a task-agnostic policy filter control system using a system-on-a-chip (SOC) for a multisensory gestural-audio interface system, in accordance with aspects of the present disclosure.

FIG. 2 is a block diagram illustrating a software architecture that may modularize artificial intelligence (AI) functions for a multisensory gestural-audio interface system of an autonomous agent, according to aspects of the present disclosure.

FIG. 3 is a diagram illustrating an example of a hardware implementation for a multisensory gestural-audio interface system, according to aspects of the present disclosure.

FIGS. 4A-4B are block diagrams illustrating an ego vehicle including a learning-based, agent action control system, according to aspects of the present disclosure.

FIG. 5 is a block diagram illustrating a learning-based, agent control action framework to control a dynamical system in such a manner that the system filters out potentially unsafe control inputs in order to stay safe during deployment.

FIG. 6 is a block diagram illustrating a task-agnostic policy filter control framework, according to aspects of the present disclosure.

FIG. 7 illustrates diagrams of an example result using the disclosed policy filter for a robot top-down visual navigation task, according to aspects of the present disclosure.

FIG. 8 illustrates snapshots of egocentric view images of a driving simulation when a vehicle is approaching a corner, according to aspects of the present disclosure.

FIG. 9 is a flowchart illustrating a method for a task-agnostic policy filter control system, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Modern advances in the representation learning literature are an enabling factor for the recent surge of a wide variety of methods for autonomous agent control directly from images or high-dimensional sensory observations. These approaches for visuomotor planning and control have the potential to solve challenging tasks in which the state of the system might not be directly observable, or even not possible to model analytically. While promising, the high dimensionality of the problem makes these methods susceptible to several open challenges.

For example, the exploration specifications of reinforcement learning (RL) algorithms are significantly exacerbated for these tasks, due to the high dimensionality of the observations. This means that trying to learn safe control policies using RL often involves accepting that abundant failures will occur during training. On the other hand, supervised learning approaches for control, such as behavioral cloning would, in principle, seem less prone to exhibit unsafe behaviors. Nevertheless, it is well known that simply because of their data-dependent nature, these methods are still susceptible to a key challenge referred to as distributional shift: if the trajectories of the system divert from the training data distribution, the controller may take unexpected actions.

On the other hand, the control theory literature extensively covers the problem of long-horizon constraint satisfaction. In particular, control barrier functions (CBFs) are an example of a model-based tool used to restrict the trajectories of the system from entering undesirable regions of the state-space. One of the desirable property of CBFs is that they decouple the problem of constraint-satisfaction from any performance objective. Specifically, if a CBF is available, a minimally invasive safety filter may be constructed for transforming any unsafe commands that an arbitrary reference policy could output into safety-preserving control actions.

Even though CBFs are model-based tools that, as such, involve knowledge of the state-space and dynamics of the system, the recent advances on learning latent state-space representations and associated dynamics models clearly set a path for linking data-driven visuomotor policy learning with the use of model-based control-theoretic tools such as CBFs. Some aspects of the present disclosure involve the use of CBFs to avoid out-of-distribution (OOD) states when using data-driven controllers for visuomotor tasks.

Some aspects of the present disclosure provide an end-to-end self-supervised approach for learning a task-agnostic policy filter which prevents the system from entering OOD states. These aspects of the present disclosure do not assume knowledge of the state-space or system dynamics. In addition, a proposed framework involves an offline-collected dataset of safe demonstrations (where the concept of safety is linked to the demonstrator's subjectivity, as it is their responsibility to provide the dataset). These aspects of the present disclosure, therefore, do not involve any unsafe demonstrations to learn a safe policy filter, in contrast to most other works tackling constrained policy learning. Use of CBFs for constructing policy filters in learned latent state-spaces endows aspects of the present disclosure with the flexibility of being applicable to systems with high-dimensional sensory observations, in contrast to most prior CBF-based methods. Beneficially, the proposed policy framework, taking raw RGB images as input, can learn to significantly reduce the distributional shift from safe demonstrations and consequently, significantly improve the safety of the control system. Although described with reference to RGB images as input, it should be recognized that the proposed framework is applicable to receiving any set of sensory observations as input.

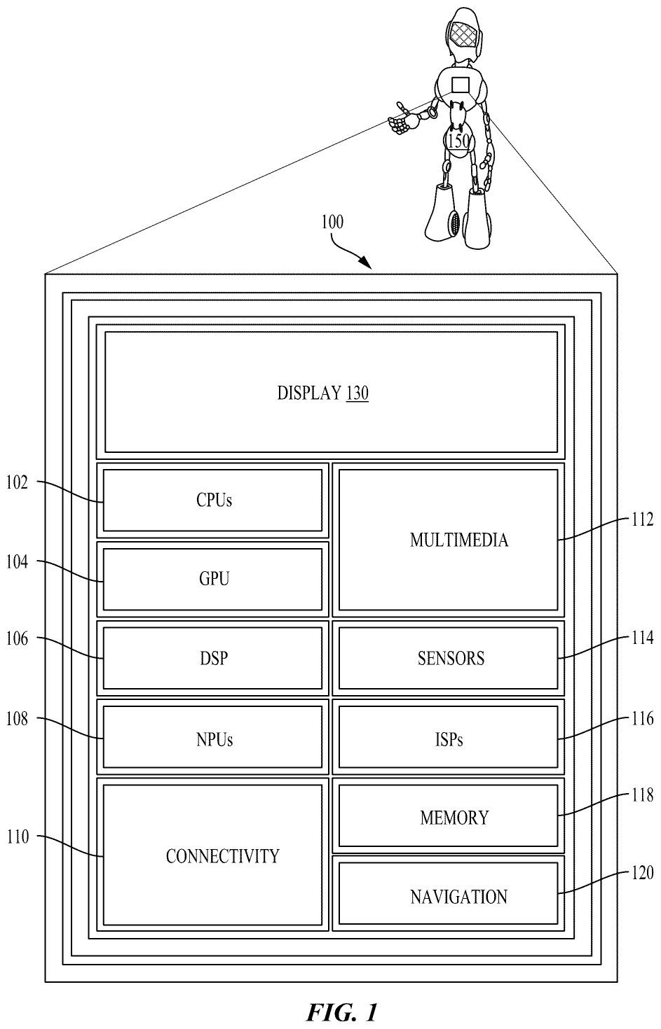

FIG. 1 illustrates an example implementation of the aforementioned system and method for a task-agnostic policy filter control system using a system-on-a-chip (SOC) 100 of an autonomous agent 150 (e.g., a robot). The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fifth generation (5G) cellular network technology, fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, apply a temporal component of a current traffic state to select a vehicle safety action, according to the display 130 illustrating a view of a vehicle. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risc Machine (ARM) instruction set or the like. In another aspect of the present disclosure, the SOC 100 may be a server computer in communication with the autonomous agent 150. In this arrangement, the autonomous agent 150 may include a processor and other features of the SOC 100. In this aspect of the present disclosure, instructions loaded into a processor (e.g., CPU 102) or the NPU 108 of the autonomous agent 150 may include program code to a task-agnostic policy filter control system based on sensor processed by the sensor processor 114.

The instructions loaded into a processor (e.g., CPU 102 or NPU 108) may also include program code to encode a current observation, a previous latent state space, and a previous action to output a new latent state space. The instructions loaded into a processor (e.g., NPU 108) may also include program code to compute, by a neural ordinary differential equations (ODE) model, ODE values in response to the new latent state. The instructions loaded into a processor (e.g., NPU 108) may also include program code to infer, by an in-distribution barrier function (iDBF) model, an iDBF value in response to the new latent state. The instructions loaded into a processor (e.g., NPU 108) may also include program code to compute, based on the ODE values, the iDBF value and a reference control input for a current timestep, a current action, in which the current action keeps the system is in-distribution with respect to an offline-collected dataset of safe demonstrations.

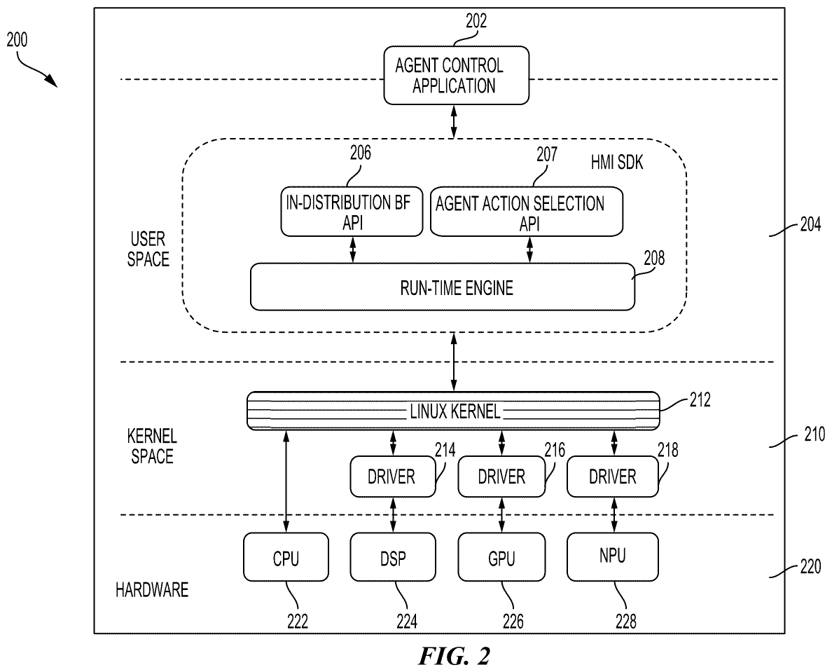

FIG. 2 is a block diagram illustrating a software architecture 200 that may modularize artificial intelligence (AI) functions for a task-agnostic policy filter control system of an autonomous agent, according to aspects of the present disclosure. Using the architecture, an agent control application 202 may be designed such that it may cause various processing blocks of a system-on-a-chip (SOC) 220 (for example a CPU 222, a DSP 224, a GPU 226, and/or an NPU 228) to perform supporting computations during run-time operation of the agent control application 202. While FIG. 2 describes the software architecture 200 for a task-agnostic policy filter control system, it should be recognized that task-agnostic policy filter control system features are not limited to autonomous agents. According to aspects of the present disclosure, a task-agnostic policy filter control system is applicable to any autonomous agent or robot, provided the agent is equipped with appropriate functions.

The agent control application 202 may be configured to call functions defined in a user space 204 that may, for example, provide for vehicle interface control services. The agent control application 202 may make a request to compile program code associated with a library defined in an in-distribution barrier function (iDBF) application programming interface (API) 206 to infer, by an in-distribution barrier function (iDBF) model, an iDBF value in response to a new latent state from learned latent-space barrier functions based on safe demonstrations. The agent control application 202 may also make a request to compile program code associated with a library defined in an agent action selection API 207 to compute, based on the ODE values, the iDBF value and a reference control input for a current timestep, a current agent control action, in which the current agent control action keeps the system in-distribution with respect to an offline-collected dataset of safe demonstrations.

A run-time engine 208, which may be compiled code of a runtime framework, may be further accessible to the agent control application 202. The agent control application 202 may cause the run-time engine 208, for example, select vehicle actions in-distribution with off-line collected safe demonstration. When the vehicle operator operates an ego vehicle, the run-time engine 208 may in turn send a signal to an operating system 210, such as a Linux Kernel 212, running on the SOC 220. FIG. 2 illustrates the Linux Kernel 212 as software architecture for implementing driver gesture tracking features for performing the task-agnostic policy filter vehicle control system. It should be recognized; however, aspects of the present disclosure are not limited to this exemplary software architecture. For example, other kernels may be used to provide the software architecture to support the task-agnostic policy filter vehicle control functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

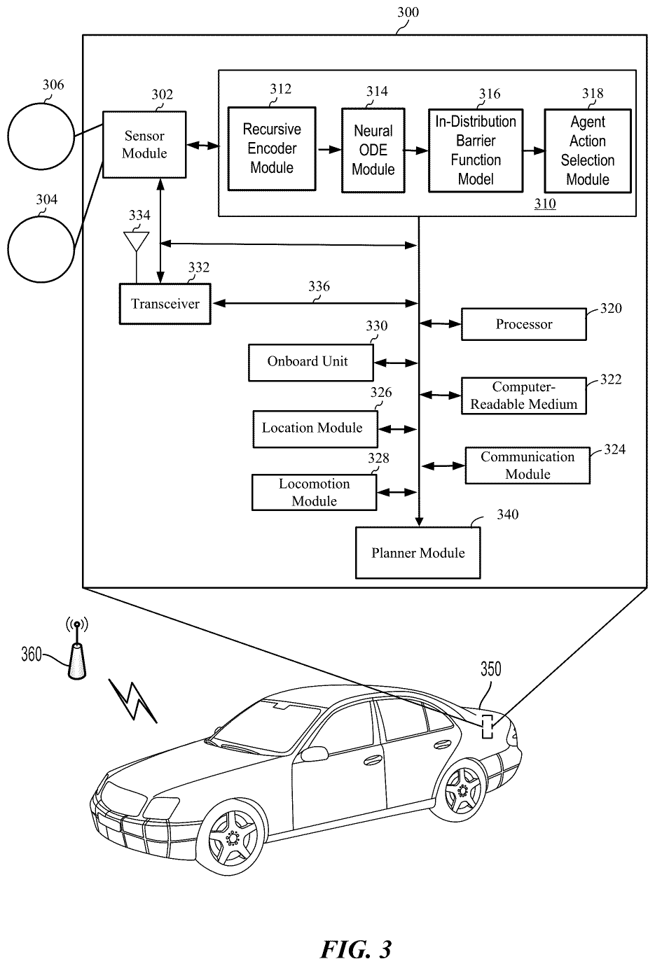

FIG. 3 is a diagram illustrating an example of a hardware implementation for a task-agnostic policy filter agent control system 300, according to aspects of the present disclosure. The task-agnostic policy filter agent control system 300 may be configured to select and perform an agent control action of an autonomous agent 350 (e.g., an autonomous vehicle) based on a selected agent control action for the autonomous agent 350 in-distribution with respect to an offline-collected dataset of safe demonstrations. The task-agnostic policy filter agent control system 300 may be a component of a vehicle, or a robotic device, or other autonomous device. For example, as shown in FIG. 3, the task-agnostic policy filter agent control system 300 is a component an autonomous vehicle, shown as the autonomous agent 350.

The task-agnostic policy filter agent control system 300 may be implemented with an interconnected architecture, such as a controller area network (CAN) bus, represented by an interconnect 308. The interconnect 336 may include any number of point-to-point interconnects, buses, and/or bridges depending on the specific application of the task-agnostic policy filter agent control system 300 and the overall design constraints. The interconnect 336 links together various circuits including one or more processors and/or hardware modules, represented by a sensor module 302, an agent controller 310, a processor 320, a computer-readable medium 322, a communication module 324, a location module 326, a locomotion module 328, an onboard unit 330, and a planner module 340. The interconnect 336 may also link various other circuits such as timing sources, peripherals, voltage regulators, and power management circuits, which are well known in the art, and therefore, will not be described any further.

The task-agnostic policy filter agent control system 300 includes a transceiver 332 coupled to the sensor module 302, the agent controller 310, the processor 320, the computer-readable medium 322, the communication module 324, the location module 326, the locomotion module 328, the onboard unit 330, and the planner module 340. The transceiver 332 is coupled to antenna 334. The transceiver 332 communicates with various other devices over a transmission medium. For example, the transceiver 332 may receive commands via transmissions from a user or a connected vehicle. In this example, the transceiver 332 may receive/transmit vehicle-to-vehicle traffic state information for the agent controller 310 to/from connected vehicles within the vicinity of the autonomous agent 350.

The task-agnostic policy filter agent control system 300 includes the processor 320 coupled to the computer-readable medium 322. The processor 320 performs processing, including the execution of software stored on the computer-readable medium 322 to provide functionality according to the disclosure. The software, when executed by the processor 320, causes the agent controller 310 to perform an agent control action of the autonomous agent 350 based on a selected agent control action selected for the autonomous agent 350 in-distribution with respect to an offline-collected dataset of safe demonstrations using any of the modules (e.g., 302, 310, 324, 326, 328, and/or 340). The computer-readable medium 322 may also be used for storing data that is manipulated by the processor 320 when executing the software.

The sensor module 302 may obtain measurements via different sensors, such as a first sensor 306 and a second sensor 304. The first sensor 306 may be a vision sensor (e.g., a stereoscopic camera or a red-green-blue (RGB) camera) for capturing 2D images of the vehicle operator. The second sensor 304 may be a ranging sensor, such as a light detection and ranging (LIDAR) sensor or a radio detection and ranging (RADAR) sensor for capturing an external vehicle environment. Of course, aspects of the present disclosure are not limited to the aforementioned sensors as other types of sensors (e.g., thermal, sonar, and/or lasers) are also contemplated for either of the first sensor 306 or the second sensor 304.

The measurements of the first sensor 306 and the second sensor 304 may be processed by the processor 320, the sensor module 302, the agent controller 310, the communication module 324, the location module 326, the locomotion module 328, the onboard unit 330, and/or the planner module 340. In conjunction with the computer-readable medium 322, the measurements of the first sensor 306 and the second sensor 304 are processed to implement the functionality described herein. In one configuration, the data captured by the first sensor 306 and the second sensor 304 may be transmitted to a connected vehicle via the transceiver 332. The first sensor 306 and the second sensor 304 may be coupled to the autonomous agent 350 or may be in communication with the autonomous agent 350.

The location module 326 may determine a location of the autonomous agent 350. For example, the location module 326 may use a global positioning system (GPS) to determine the location of the autonomous agent 350. The location module 326 may implement a dedicated short-range communication (DSRC)-compliant GPS unit. A DSRC-compliant GPS unit includes hardware and software to make the autonomous agent 350 and/or the location module 326 compliant with one or more of the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

The communication module 324 may facilitate communications via the transceiver 332. For example, the communication module 324 may be configured to provide communication capabilities via different wireless protocols, such as 6G, 5G NR. Wi-Fi, long term evolution (LTE), 4G, 3G, etc. The communication module 324 may also communicate with other components of the autonomous agent 350 that are not modules of the task-agnostic policy filter agent control system 300. The transceiver 332 may be a communications channel through a network access point 360. The communications channel may include DSRC, 6G, 5G NR, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G. 4G, 5G NR, 6G, LTE, LTE-V2X, LTE-D2D, VOLTE, or any other mobile data network or combination of mobile data networks. Further, the network access point 360 may include one or more IEEE 802.11 wireless networks.

The task-agnostic policy filter agent control system 300 also includes the planner module 340 for planning a route and controlling the locomotion of the autonomous agent 350, via the locomotion module 328 for autonomous operation of the autonomous agent 350. In one configuration, the planner module 340 may override a user input when the user input is expected (e.g., predicted) to cause a collision according to an autonomous level of the autonomous agent 350. The modules may be software modules running in the processor 320, resident/stored in the computer-readable medium 322, and/or hardware modules coupled to the processor 320, or some combination thereof.

The National Highway Traffic Safety Administration (“NHTSA”) has defined different “levels” of autonomous vehicles (e.g., Level 0, Level 1, Level 2, Level 3, Level 4, and Level 5). For example, if an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. These various levels of autonomous vehicles are described briefly below.

Level 0: In a Level 0 vehicle, the set of advanced driver assistance system (ADAS) features installed in a vehicle provide no vehicle control but may issue warnings to the driver of the vehicle. A vehicle which is Level 0 is not an autonomous or semi-autonomous vehicle.

Level 1: In a Level 1 vehicle, the driver is ready to take driving control of the autonomous vehicle at any time. The set of ADAS features installed in the autonomous vehicle may provide autonomous features such as: adaptive cruise control (“ACC”); parking assistance with automated steering; and lane keeping assistance (“LKA”) type II, in any combination.

Level 2: In a Level 2 vehicle, the driver is responsible for detecting objects and events in the roadway environment and respond if the set of ADAS features installed in the autonomous vehicle fail to respond properly (based on the driver's subjective judgement). The set of ADAS features installed in the autonomous vehicle may include accelerating, braking, and steering. In a Level 2 vehicle, the set of ADAS features installed in the autonomous vehicle can deactivate immediately upon takeover by the driver.

Level 3: In a Level 3 ADAS vehicle, within known, limited environments (such as freeways), the driver can safely turn their attention away from driving tasks but is still be prepared to take control of the autonomous vehicle when needed.

Level 4: In a Level 4 vehicle, the set of ADAS features installed in the autonomous vehicle can control the autonomous vehicle in all but a few environments, such as severe weather. The driver of the Level 4 vehicle enables the automated system (which is comprised of the set of ADAS features installed in the vehicle) only when it is safe to do so. When the automated Level 4 vehicle is enabled, driver attention is not required for the autonomous vehicle to operate safely and consistent within accepted norms.

Level 5: In a Level 5 vehicle, other than setting the destination and starting the system, no human intervention is involved. The automated system can drive to any location where it is legal to drive and make its own decision (which may vary based on the jurisdiction where the vehicle is located).

A highly autonomous vehicle (“HAV”) is an autonomous vehicle that is Level 3 or higher. Accordingly, in some configurations the autonomous agent 350 is one of the following: a Level 1 autonomous vehicle; a Level 2 autonomous vehicle; a Level 3 autonomous vehicle; a Level 4 autonomous vehicle; a Level 5 autonomous vehicle; and an HAV.

The agent controller 310 may be in communication with the sensor module 302, the processor 320, the computer-readable medium 322, the communication module 324, the location module 326, the locomotion module 328, the onboard unit 330, the transceiver 332, and the planner module 340. In one configuration, the agent controller 310 receives sensor data from the sensor module 302. The sensor module 302 may receive the sensor data from the first sensor 306 and the second sensor 304. According to aspects of the present disclosure, the sensor module 302 may filter the data to remove noise, encode the data, decode the data, merge the data, extract frames, or perform other functions. In an alternate configuration, the agent controller 310 may receive sensor data directly from the first sensor 306 and the second sensor 304 to determine, for example, input traffic data images.

Learning-based control approaches have shown great promise in performing complex tasks directly from high-dimensional perception data for real robotic systems. Nonetheless, the learned controllers can behave unexpectedly if the trajectories of the system divert from the training data distribution, which can compromise safety. Modern advances in the representation learning literature are an enabling factor for the recent surge of a wide variety of methods for autonomous agent control directly from images or high-dimensional sensory observations. These approaches for visuomotor planning and control have the potential to solve challenging tasks in which the state of the system might not be directly observable, or even not possible to model analytically. While promising, the high dimensionality of the problem makes these methods susceptible to several open challenges.

Some aspects of the present disclosure are directed to a control filter that wraps any reference policy and effectively encourages the system to stay in-distribution with respect to offline-collected safe demonstrations. Some aspects of the present disclosure rely on control barrier functions (CBFs), which are model-based tools from the nonlinear control literature that can be used to construct minimally invasive safe policy filters. While existing methods based on CBFs involve a known low-dimensional state representation, some aspects of the present disclosure are directly applicable to systems that rely solely on high-dimensional sensory observations by learning in a latent state-space. A control filter-based method according to some aspects of the present disclosure is effective for two different visuomotor control tasks in simulation environments, including both top-down and egocentric view settings.

In these aspects of the present disclosure, the task-agnostic policy filter agent control system 300 selects a current agent control action for the autonomous agent 350, in which the selected agent control action keeps the task-agnostic policy filter agent control system 300 in-distribution with respect to an offline-collected dataset of safe demonstrations. As shown in FIG. 3, the task-agnostic policy filter agent control system 300 includes the agent controller 310 to select a current vehicle control action that keeps the task-agnostic policy filter agent control system 300 in-distribution with respect to an offline-collected dataset of safe demonstrations. In this example, the agent controller 310 includes a recursive encoder module 312, a neural ordinary differential equation (ODE) module 314, an in-distribution barrier function model 316, and an agent action selection module 318. The recursive encoder module 312, the neural ODE module 314, the in-distribution barrier function model 316, and the agent action selection module 318 may be components of a same or different artificial neural network, such as a deep convolutional neural network (CNN). The agent controller 310 is not limited to a CNN.

In some aspects of the present disclosure, the recursive encoder module 312 is configured to encode a current observation, a previous latent state, and a previous action to output a new latent state. Additionally, the neural ODE module 314 is configured to compute learned latent state-space dynamic models for the new latent state. In some aspects of the present disclosure, the agent controller 310 is further configured to map, by a decoder, the current latent state to a reconstruction of observations and control inputs from a safe dataset derived during training. The agent controller 310 operates according to the in-distribution barrier function model 316 configured to infer an iDBF value in response to a new latent state from learned latent-space barrier functions based on safe demonstrations. Additionally, the agent action selection module 318 is configured to compute, based on the ODE values, the iDBF value and a reference control input for a current timestep, a current vehicle control action, in which the selected vehicle control action is in-distribution with respect to an offline-collected dataset of safe demonstrations.

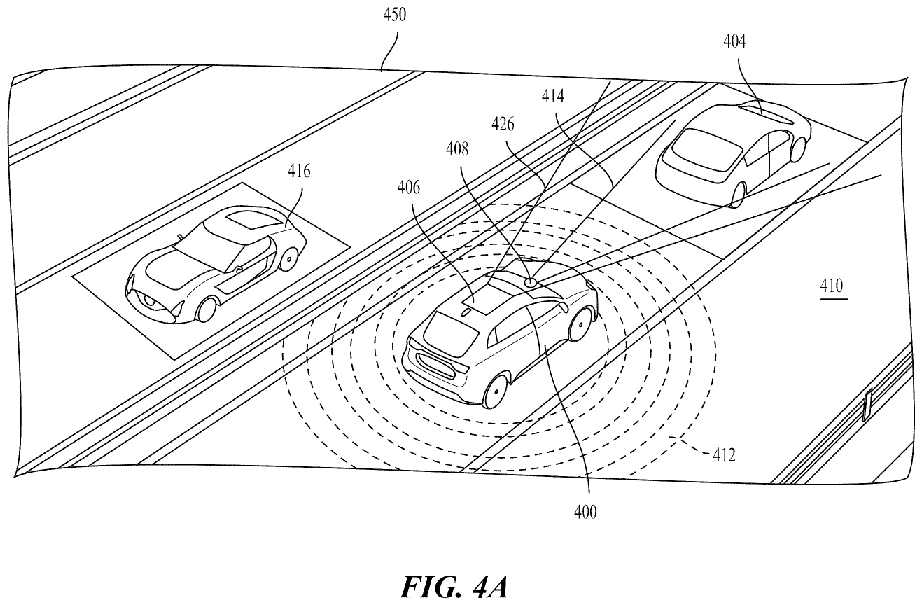

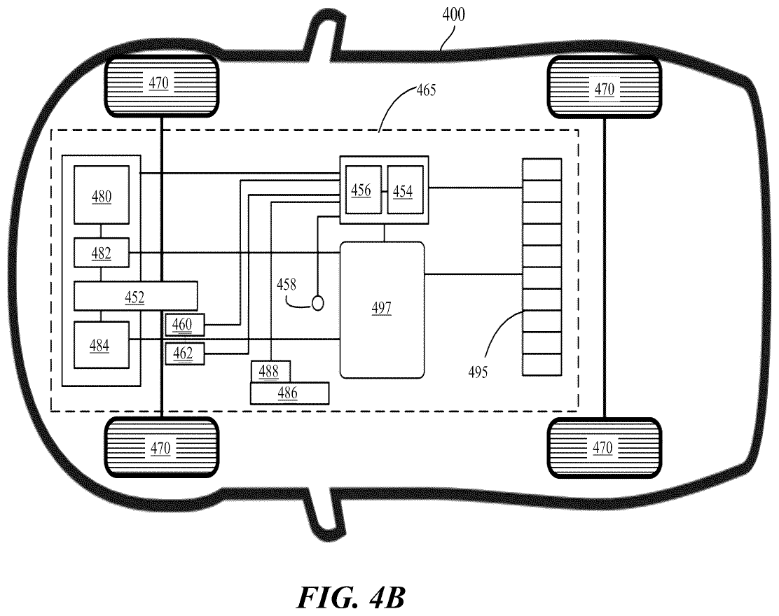

Various aspects of the present disclosure may be implemented in an agent, such as a vehicle. The vehicle may operate in either an autonomous mode, a semi-autonomous mode, or a manual mode. In some examples, the vehicle may switch between operating modes. FIG. 4A is a diagram illustrating an example of a vehicle 400 in an environment 450, in accordance with various aspects of the present disclosure. In the example of FIG. 4A, the vehicle 400 may be an autonomous vehicle, a semi-autonomous vehicle, or a non-autonomous vehicle. As shown in FIG. 4A, the vehicle 400 may be traveling on a road 410. A first vehicle 404 may be ahead of the vehicle 400 and a second vehicle 416 may be adjacent to the vehicle 400. In this example, the vehicle 400 may include a 2D camera 408, such as a 2D red-green-blue (RGB) camera, and a LIDAR sensor 406. The 2D camera 408 and the LIDAR sensor 406 may be components of an overall sensor system (e.g., the sensor module 302). Other sensors, such as radar and/or ultrasound, are also contemplated. Additionally, or alternatively, although not shown in FIG. 4A, the vehicle 400 may include one or more additional sensors, such as a camera, a radar sensor, and/or a LIDAR sensor, integrated with the vehicle in one or more locations, such as within one or more storage locations (e.g., a trunk). Additionally, or alternatively, although not shown in FIG. 4A, the vehicle 400 may include one or more force measuring sensors.

In one configuration, the 2D camera 408 captures a 2D image that includes objects in the 2D camera's 408 field of view 414. The LIDAR sensor 406 may generate one or more output streams. The first output stream may include a three-dimensional (3D) cloud point of objects in a first field of view, such as a 360° field of view 412 (e.g., bird's eye view). The second output stream 424 may include a 3D cloud point of objects in a second field of view, such as a forward-facing field of view, such as the 2D camera's 408 field of view 414 and/or the 2D sensor's 406 field of view 426.

The 2D image captured by the 2D camera 408 includes a 2D image of the first vehicle 404, as the first vehicle 404 is in the 2D camera's 408 field of view 414. As is known to those of skill in the art, a LIDAR sensor 406 uses laser light to sense the shape, size, and position of objects in an environment. The LIDAR sensor 406 may vertically and horizontally scan the environment. In the current example, the artificial neural network (e.g., autonomous driving system) of the vehicle 400 may extract height and/or depth features from the first output stream. In some examples, an autonomous driving system of the vehicle 400 may also extract height and/or depth features from the second output stream 424.

The information obtained from the LIDAR sensor 406 and the 2D camera 408 may be used to evaluate a driving environment. In some examples, the information obtained from the LIDAR sensor 406 and the 2D camera 408 may identify whether the vehicle 400 is at an intersection or a crosswalk. Additionally, or alternatively, the information obtained from the LIDAR sensor 406 and the 2D camera 408 may identify whether one or more dynamic objects, such as pedestrians, are near the vehicle 400.

FIG. 4B is a diagram illustrating an example of a vehicle 400, in accordance with various aspects of the present disclosure. It should be understood that various aspects of the present disclosure may be directed to an autonomous vehicle. The autonomous vehicle may be an internal combustion engine (ICE) vehicle, fully electric vehicle (EV), or another type of vehicle. The vehicle 400 may include drive force unit 465 and wheels 470. The drive force unit 465 may include an engine 480, motor generators (MGs) 482 and 484, a battery 495, an inverter 497, a brake pedal 486, a brake pedal sensor 488, a transmission 452, a memory 454, an electronic control unit (ECU) 456, a shifter 458, a speed sensor 460, and an accelerometer 462.

The engine 480 primarily drives the wheels 470. The engine 480 can be an ICE that combusts fuel, such as gasoline, ethanol, diesel, biofuel, or other types of fuels which are suitable for combustion. The torque output by the engine 480 is received by the transmission 452. The MGs 482 and 484 can also output torque to the transmission 452. The engine 480 and the MGs 482 and 484 may be coupled through a planetary gear (not shown in FIG. 4B). The transmission 452 delivers an applied torque to one or more of the wheels 470. The torque output by the engine 480 does not directly translate into the applied torque to the one or more wheels 470.

The MGs 482 and 484 can serve as motors which output torque in a drive mode and can serve as generators to recharge the battery 495 in a regeneration mode. The electric power delivered from or to the MGs 482 and 484 passes through the inverter 497 to the battery 495. The brake pedal sensor 488 can detect pressure applied to the brake pedal 486, which may further affect the applied torque to the wheels 470. The speed sensor 460 is connected to an output shaft of the transmission 452 to detect a speed input which is converted into a vehicle speed by the ECU 456. The accelerometer 462 is connected to the body of the vehicle 400 to detect the actual deceleration of the vehicle 400, which corresponds to a deceleration torque.

The transmission 452 may be a transmission suitable for any vehicle. For example, the transmission 452 can be an electronically controlled continuously variable transmission (ECVT), which is coupled to the engine 480 as well as to the MGs 482 and 484. The transmission 452 can deliver torque output from a combination of the engine 480 and the MGs 482 and 484. The ECU 456 controls the transmission 452, utilizing data stored in the memory 454 to determine the applied torque delivered to the wheels 470. For example, the ECU 456 may determine that at a certain vehicle speed, the engine 480 should provide a fraction of the applied torque to the wheels 470 while one or both of the MGs 482 and 484 provide most of the applied torque. The ECU 456 and the transmission 452 can control an engine speed (NE) of the engine 480 independently of the vehicle speed (V).

The ECU 456 may include circuitry to control the above aspects of vehicle operation. Additionally, the ECU 456 may include, for example, a microcomputer that includes one or more processing units (e.g., microprocessors), memory storage (e.g., RAM, ROM, etc.), and I/O devices. The ECU 456 may execute instructions stored in memory to control one or more electrical systems or subsystems in the vehicle 400. Furthermore, the ECU 456 can include one or more electronic control units such as, for example, an electronic engine control module, a powertrain control module, a transmission control module, a suspension control module, a body control module, and so on. As a further example, electronic control units may control one or more systems and functions such as doors and door locking, lighting, human-machine interfaces, cruise control, telematics, braking systems (e.g., anti-lock braking system (ABS) or electronic stability control (ESC)), or battery management systems, for example. These various control units can be implemented using two or more separate electronic control units, or a single electronic control unit.

The MGs 482 and 484 each may be a permanent magnet type synchronous motor including, for example, a rotor with a permanent magnet embedded therein. The MGs 482 and 484 may each be driven by an inverter controlled by a control signal from the ECU 456, so as to convert direct current (DC) power from the battery 495 to alternating current (AC) power and supply the AC power to the MGs 482 and 484. In some examples, a first MG 482 may be driven by electric power generated by a second MG 484. It should be understood that in embodiments where MGs 482 and 484 are DC motors, no inverter is required. The inverter 497, in conjunction with a converter assembly, may also accept power from one or more of the MGs 482 and 484 (e.g., during engine charging), convert this power from AC back to DC, and use this power to charge the battery 495 (hence the name, motor generator). The ECU 456 may control the inverter 497, adjust driving current supplied to the first MG 482, and adjust the current received from the second MG 484 during regenerative coasting and braking.

The battery 495 may be implemented as one or more batteries or other power storage devices including, for example, lead-acid batteries, lithium ion and nickel batteries, capacitive storage devices, and so on. The battery 495 may also be charged by one or more of the MGs 482 and 484, such as, for example, by regenerative braking or coasting, during which one or more of the MGs 482 and 484 operates as a generator. Alternatively, or additionally, the battery 495 can be charged by the first MG 482, for example, when the vehicle 400 is idle (not moving/not in drive). Further still, the battery 495 may be charged by a battery charger (not shown) that receives energy from the engine 480. The battery charger may be switched or otherwise controlled to engage/disengage it with the battery 495. For example, an alternator or generator may be coupled directly or indirectly to a drive shaft of the engine 480 to generate an electrical current as a result of the operation of the engine 480. Still other embodiments contemplate the use of one or more additional motor generators to power the rear wheels of the vehicle 400 (e.g., in vehicles equipped with 4-Wheel Drive), or using two rear motor generators, each powering a rear wheel.

The battery 495 may also power other electrical or electronic systems in the vehicle 400. In some examples, the battery 495 can include, for example, one or more batteries, capacitive storage units, or other storage reservoirs suitable for storing electrical energy that can be used to power one or both of the MGs 482 and 484. When the battery 495 is implemented using one or more batteries, the batteries can include, for example, nickel metal hydride batteries, lithium-ion batteries, lead acid batteries, nickel cadmium batteries, lithium-ion polymer batteries, or other types of batteries.

The vehicle 400 may operate in one of an autonomous mode, a manual mode, or a semi-autonomous mode. In the manual mode, a human driver manually operates (e.g., controls) the vehicle 400. In the autonomous mode, an autonomous control system (e.g., autonomous driving system) operates the vehicle 400 without human intervention. In the semi-autonomous mode, the human may operate the vehicle 400, and the autonomous control system may override or assist the human. For example, the autonomous control system may override the human to prevent a collision or to obey one or more traffic rules.

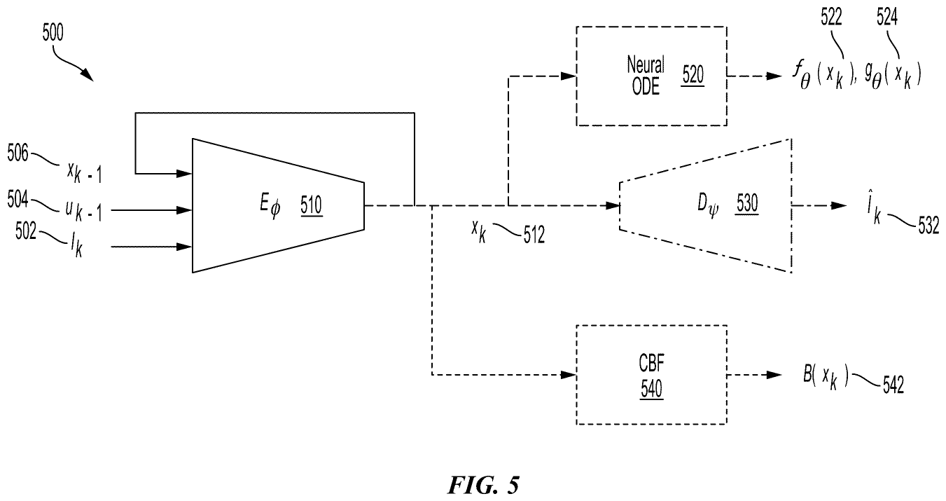

FIG. 5 is a block diagram illustrating a novel learning-based, vehicle control action framework 500 to control a dynamical system in such a manner that the system filters out potentially unsafe control inputs in order to stay safe during deployment. This vehicle control action framework 500 leverages offline-collected safe demonstrations in the form of raw sensory observations 502, such as RGB images. In some aspects of the present disclosure, the vehicle control action framework 500 converts offline demonstrations using a minimally invasive safety filter that aims to prevent an automatic controller or a control policy from going into unsafe situations at run time.

In operation, the vehicle control action framework 500 simultaneously learns 1) a safe set, 2) an iDBF 542 from an iDBF block 540, 3) an underlying, latent state 512, and 4) dynamics function in the latent space, from an offline set of safe demonstrations in the form of raw sensor data. This configuration of the vehicle control action framework 500 removes the necessity for any system-related prior knowledge and can scale up to a large amount of data.

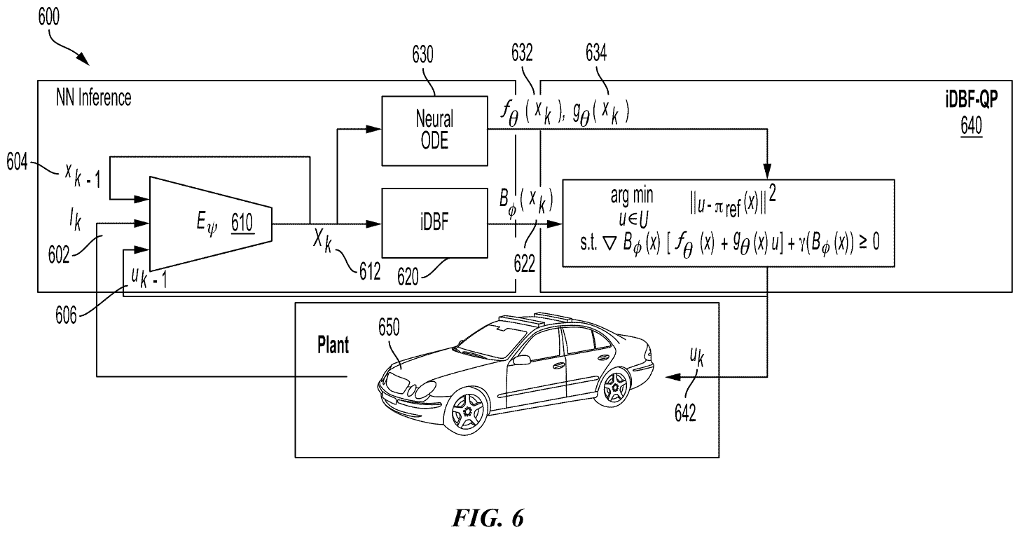

As shown in FIG. 5, the vehicle control action framework 500 includes a recursive encoder 510 that sequentially takes in the raw sensory observations 502 (e.g., streamed RGB images), coupled with a previous control input 504 and a previous latent space state 506. In some aspects of the present disclosure, the raw sensory observations 502 and the control input 504 are provided by a safe demonstrations dataset during training, while the latent state is given by the previous output from the recursive encoder 510. Additionally, a decoder 530 maps the latent state 512 to the corresponding raw sensory observations 502 to provide a reconstructed observation 532. A neural ordinary differential equation (ODE) block 520 outputs ODE values 522, 524 that describe the learned dynamics of the system in the latent state 512. Additionally, the iDBF block 540 measures a safety score of the latent state 512 and that, together with the learned dynamics model, yields an optimization-based safe controller, as further illustrated in FIG. 6.

### 1. Control Barrier Functions

As described, control barrier functions (CBFs) are tools from the nonlinear control literature that serve to enforce safety constraints for systems with known dynamics. Additionally, CBFs are particularly well-suited for continuous-time nonlinear control-affine systems of the form

$$\dot{x} = f ( x ) + g ( x ) u , \qquad ( 1 )$$

where x∈X⊂ [symbol] ⁿ is the state and u∈ [symbol] ⊂ [symbol] ^{m} the control input. This description assumes that f:X→ [symbol] ⁿ and g:X→ [symbol] ^{n×m} are locally Lipschitz continuous.

In the context of CBF, safety is considered as a set invariance problem. In particular, a control policy π:X→ [symbol] assures the safety of system (1) with respect to a set of X_{safe}⊂X if the set X_{safe} is forward invariant under the control law π, i.e., for any x₀∈X_{safe}, the solution x(t) of system (1) under control law π remains within X_{safe} for all t≥0.

Definition 1 (Control Barrier Function) A continuously differentiable function B:X→ [symbol] is a control barrier function (CBF) for system (1) with associated safe-set X_{safe}⊂X if the following three conditions are satisfied:

$$B ( x ) \geq 0 ∀ x ∈ {χ}_{safe} , \qquad ( 2 )$$

$$B ( x ) < 0 ∀ x ∈ χ \backslash {χ}_{safe} , \qquad ( 3 )$$

$$∃ u ∈ 𝒰 s . t . \dot{B} ( x , u ) + γ ( B ( x ) ) \geq 0 ∀ x ∈ χ , \qquad ( 4 )$$

where γ: [symbol] → [symbol] is an extended class [symbol] _{∞} function.

The existence of a CBF B guarantees that for system of Equation (1) any Lipschitz continuous control policy π satisfying

$$π ( x ) ∈ \{ u ∈ 𝒰 : {\underbrace{∇ B ( x ) [ f ( x ) + g ( x ) u ]}}_{= \dot{B} ( x , u )} + γ ( B ( x ) ) \geq 0 \} \qquad ( 5 )$$

will render the set X_{safe} forward invariant.

For a given task-specific reference controller π_{ref}:X→ [symbol] that might be safety-agnostic, the condition of Equation (5) can be used to formulate an optimization problem that, when solved at every time-step, yields a minimally invasive policy safety filter:

$${π}_{CBF} ( x ) = {arg min}_{u ∈ 𝒰} {‖ u - {π}_{ref} ( x ) ‖}^{2} \qquad ( CBF - OP )$$

$$s . t . ∇ B ( x ) [ f ( x ) + g ( x ) u ] + γ ( B ( x ) ) \geq 0.$$

If the actuation constraints that define [symbol] are linear in u, this problem is a quadratic program (QP). This is a consequence of the dynamics of the system Equation (1) being control-affine, and it practically means that the problem can be solved to a high precision very quickly (around 10³ Hz). This is significant because the CBF-QP is solved at the real-time control frequency.

### 2. Problem Statement

The CBF-QP constitutes a very appealing approach for practitioners: it provides a task-agnostic minimally invasive filter that can wrap safety around any given policy π_{ref}, and, therefore, rewrite any unsafe control input that π_{ref} could output at any time. Nevertheless, designing a valid CBF is nontrivial. In fact, it is still an active research topic even when assuming perfect knowledge of the dynamics of the system. The two main difficulties in the design of a CBF are the following: first, a control-invariant set X_{safe} is obtained (which in general is different from the geometric constraint set that could be obtained, for instance, from a signed-distance field) and, second, a function that satisfies condition of Equation (4) must be found for that set. Furthermore, even after obtaining a CBF, solving the CBF-QP requires perfect state and dynamics knowledge.

In some aspects of the present disclosure, the agent action control framework 500 of FIG. 5 provides the initial components towards building a safe policy filter from high-dimensional observations. Specifically, CBFs are used to design the vehicle control action framework 500 as an end-to-end learning framework to constrain deep learning models to remain in-distribution of the training data. During a training phase, the agent action control framework 500 receives an input dataset of high-dimensional observations of different safe demonstrations and builds a neural CBF-like function that encourages the vehicle control action framework 500 to stay in-distribution with respect to the observations from the safe demonstrations. This, in turn, significantly improves the safety of the vehicle control action framework 500 during deployment.

More concretely, for a given dataset of N safe trajectories

$$𝔻 = {\{ {( {I}_{t}^{i} , {u}_{t}^{i} )}_{t = 0}^{t = {T}_{i}} \}}_{i = 1}^{i = N}$$

aspects of the present disclosure solve the problem of designing a policy filter that can be applied to any reference controller π_{ref} to detect and override actions from the reference controller π_{ref} that lead to out-of-distribution (OOD) states. The following description denotes Iₜⁱ and uₜⁱ as the high-dimensional observation and the control input, respectively, measured at time t for an ith trajectory. Furthermore, Tᵢ is the final time-step of trajectory i. The demonstrations in the dataset [symbol] might correspond to different tasks and the different task may not be optimal with respect to any objective. In fact, a single assumption is that the dataset is limited to safe demonstrations (e.g., in the sense that these trajectories do not contain any states from which the vehicle control action framework 500 is deemed to fail, even if it has not failed yet), for encouraging long-term constraint satisfaction using CBFs.

### 3. In-Distribution Barrier Functions

The following description introduces a self-supervised approach for synthesizing neural CBF-like functions whose aim is to constrain the vehicle control action framework 500 to remain in-distribution with respect to an offline dataset of safe demonstrations. As described, these functions are referred to as in-distribution barrier functions (iDBFs). The following description assume the availability of a parametric continuous-time control-affine model of the dynamics of the vehicle control action framework 500 in a state-space X⊂ [symbol] ⁿ

$$\dot{x} = {f}_{θ} ( x ) + {g}_{θ} ( x ) u , \qquad ( 6 )$$

and present the iDBF learning procedure for the vehicle control action framework 500. Furthermore, the following description assumes that the dataset [symbol] of safe trajectories contains true state measurements, i.e.,

$$𝔻 = {\{ {( {x}_{t}^{i} , {u}_{t}^{i} )}_{t = 0}^{t = {T}_{i}} \}}_{i = 1}^{i = N} ,$$

where xₜⁱ and uₜⁱ are the state and control input, respectively, measured at time t for the ith trajectory. In Section 4, details are provided on how to learn a dynamics model of this form in a latent state-space when having a dataset containing high-dimensional sensory observations.

Some aspects of the present disclosure parameterize an iDBF B_{ϕ}:X→ [symbol] as a neural network with parameters ϕ, and construct an empirical loss function that encourages it to satisfy the three CBF conditions of Equations (2), (3), and (4) with respect to a set X_{safe} that is also implicitly learned through self-supervision. Additionally, design of the loss function may be based on learning CBFs. Nevertheless, instead of assuming that the safe-set X_{safe} is given and sampled from, as well as from an unsafe complement X_{unsafe}≐X\X_{safe}, a loss function is built in a self-supervised manner just from the dataset of safe demonstrations. Build of the loss function may be accomplished by leveraging ideas from contrastive learning. In particular, as described in further detail below, a contrastive distribution is built from which to sample candidate unsafe states, given that unsafe demonstrations are not included in the disclosed dataset. The proposed loss function for learning an iDBF takes the following form:

$${ℒ}_{iDBF} = \frac{{w}_{safe}}{{N}_{safe}} {\sum }_{{x}_{safe}} {[ {ϵ}_{safe} - {B}_{ϕ} ( {x}_{safe} ) ]}^{+} + \frac{{w}_{unsafe}}{{N}_{unsafe}} {\sum }_{{x}_{usafe}} {[ {ϵ}_{unsafe} - {B}_{ϕ} ( {x}_{unsafe} ) ]}^{+} + \frac{{w}_{ascent}}{{N}_{safe}} \text{} {\sum }_{( {x}_{safe} , {u}_{safe} )} \text{} {[ {ϵ}_{ascent} - ( ∇ {B}_{ϕ} ( {x}_{safe} ) [ {f}_{θ} ( {x}_{safe} ) + {g}_{θ} ( {x}_{safe} ) {u}_{safe} ] + γ ( {B}_{ϕ} ( {x}_{safe} ) ) ) ]}^{+} , \qquad ( 7 )$$

where [.]⁺:=max(0,·); (x_{safe}, u_{safe}) are samples from the empirical distribution of the dataset [symbol] ; x_{unsafe} are samples from a contrastive distribution, as defined below; w_{safe}, w_{unsafe} and w_{ascent} are the weights of the different loss terms; and ϵ_{safe}, ϵ_{unsafe} and ϵ_{ascent} are positive constants that serve to enforce strictly the inequalities and generalize outside of the training data.

The goal of the first two terms in the loss function is to learn an iDBF that has a positive value in states that belong to the data distribution of safe demonstrations, and negative elsewhere. In particular, an iDBF having negative value in states that do not belong to the data distribution of safe demonstrations encourages satisfaction of the conditions (2) and (3) of the definition of CBF. It should be recognized that this classification objective is related to the notion of energy-based models (EBMs)—neural network density models that assign a low energy value to points close to the training data distribution and a high value to points that are far from the training data distribution. Intuitively, these methods use a noise contrastive distribution to generate candidate examples where to increase the value of the energy of the EBM, while decreasing the energy at the training data points. The opposite result is desired to solve the present problem: a high value of B_{ϕ} on the training data distribution, and a low value elsewhere. Nevertheless, an additional specification is an iDBF having a value of zero at the boundary, as set by conditions (2) and (3). This is the reason the two first terms of the loss function are designed using the [·]⁺ operator.

In the third term of the loss (7), it is noted that the satisfaction of condition (4) is not encouraged over the entire state-space, but only over the dataset of safe demonstrations. Nevertheless, in the definition of CBF, if condition (4) is only satisfied ∀x∈X_{safe} instead of ∀x∈X, the CBF still guarantees the control-invariance of X_{safe}. Aspects of the present disclosure, therefore, using an empirical data distribution of safe demonstrations as a sampling distribution covering the set X_{safe}, which are also implicitly learned as the zero-superlevel set of B_{ϕ}. Furthermore, all pairs (x_{safe}, u_{safe}) present in the dataset [symbol] are used to compute this term of the loss. This way, the set of admissible control inputs (5) are forced to be as large as the disclosed dataset allows, reducing the conservatism of the learned iDBF.

In order to generate the contrastive distribution from which to sample x_{unsafe}, learning the iDBF in a latent state-space, in which constructing a noise distribution might not be intuitive, is performed using the following steps. 1) Based on the dataset of safe demonstrations [symbol] , a neural behavioral cloning (BC) model is trained that outputs a multi-modal Gaussian distribution over actions conditioned on the state, with density π_{BC}(u|x). 2) Then, during the training process of the iDBF, for each x_{safe} state sampled from [symbol] randomly takes N_{candidate} control inputs u_{candidate} and evaluates their density value based on the BC model π_{BC}(u_{candidate}|x_{safe}). 3) If the value of the density falls below a threshold, then that control input is forward propagated for one timestep using the dynamics model (6) to generate a sample x_{unsafe}. This way, a contrastive data distribution is generated by propagating actions that are unlikely present in the dataset of safe demonstrations. Furthermore, by only propagating these actions for one timestep, the contrastive distribution is close to the training data, which is desirable for the learning process.

FIG. 6 is a block diagram illustrating a task-agnostic policy filter control framework 600, according to aspects of the present disclosure. In some aspects of the present disclosure, the task-agnostic policy filter vehicle control framework shown in FIG. 6 illustrates an inference diagram of the task-agnostic policy filter control framework 600. During operation of the task-agnostic policy filter control framework 600, at each timestep, based on the current observation I_{κ} 602, the previous latent state 604 and the previous action 606, the autoencoder network 610 E_{ψ} outputs a new latent state x_{κ} 612. Then, the iDBF module 620 generates an iDBF value 622 (B_{θ}(x_{κ}), and the dynamics networks (e.g., a neural ordinary differential equations (ODE) module 630) generate ODE values 632, 634 (e.g., f_{θ}(x_{κ}) and g_{θ}(x_{κ})) which are passed to a iDBF-QP policy filter 640. The iDBF-QP policy filter 640 takes a reference control input for the current timestep π_{ref}(x_{κ}) and returns the closest action 642 that keeps the system in-distribution with respect to the offline-collected dataset of safe demonstrations. For both of the examples described below, the total inference time (NN Inference+solving the iDBF-QP) of the task-agnostic policy filter control framework 600 is less than 5 milliseconds.

4. Learning iDBFs from High-Dimensional Observations

After introducing the training procedure for an iDBF when the state representation and dynamics model of Equation (6) are given, these assumptions are relaxed and an approach is presented to learn a latent state-space representation and a continuous-time dynamics model of the form Equation (6), suitable to be integrated in the same end-to-end learning framework. Next, the problem setting described in Section 4 is considered, in which access to a dataset containing observation-action pairs of safe demonstrations

$$𝔻 = {\{ {( {I}_{t}^{i} , {u}_{t}^{i} )}_{t = 0}^{t = {T}_{i}} \}}_{i = 1}^{i = N}$$

is assumed.

Some aspects of the present disclosure use an autoencoder architecture to obtain the latent state-space representation and employ the training procedure of Neural Ordinary Differential Equations to learn a dynamics model of the form Equation (6) in the latent state-space. Note that enforcing the continuous-time control-affine structure of the dynamics model ensures that the iDBF-QP policy filter (equivalent to the CBF-QP, see FIG. 6) obtained with the learned iDBF and dynamics model will also be a quadratic program.

The inference procedure of an end-to-end learning, task-agnostic policy filter control framework 600 is depicted in FIG. 6. In some aspects of the present disclosure, the task-agnostic policy filter control framework 600 use a recursive, autoencoder network 610 E_{ψ} that takes the current observation I_{κ} 602, as well as the previous latent state 604 (x_{κ-1}) and the previous action 606 (u_{κ-1}) to generate the new latent state space 612x_{κ} at each time-step κ. The decoder network D_{ξ} (see FIG. 5) generates a reconstructed observation Î_{κ} for each latent state x_{κ}. The proposed loss function for the latent state-space representation and dynamics model penalizes both the prediction error of the dynamics model and the observation reconstruction error:

$${ℒ}_{dyn} = \frac{1}{{N}_{dyn} ( {T}_{pred} + 1 )} {\sum }_{j = 1}^{{N}_{dyn}} {\sum }_{κ = 0}^{{T}_{pred}} [ \text{} {w}_{state} {‖ {\tilde{x}}_{{t}_{j} + κ \vert {t}_{j}} - {x}_{{t}_{j} + κ} ‖}^{2} + {w}_{{rec}_{1}} {‖ {\tilde{I}}_{{t}_{j} + κ \vert {t}_{j}} - {I}_{{t}_{j} + κ} ‖}^{2} + {w}_{{rec}_{2}} {‖ {\hat{I}}_{{t}_{j} + κ} - {I}_{{t}_{j} + κ} ‖}^{2} ] . \qquad ( 8 )$$

Here, xₜ_{ⱼ}_{+κ}=E_{ψ}(Iₜ_{ⱼ}_{+κ}, xₜ_{ⱼ}_{+κ-1}, uₜ_{ⱼ}+κ−1) is the latent state at timestep tⱼ+κ. \tilde{x}ₜ_{ⱼ}_{+κ|t}_{ⱼ} denotes the latent state prediction obtained by forward-propagating the dynamics model (6) to timestep tⱼ+κ starting from the state xₜ_{ⱼ} and using zero-order hold on the sequence of control inputs (uₜ_{ⱼ}, uₜ_{ⱼ}₊₁, . . . , xₜ_{ⱼ}_{+κ-1}). Additionally, Ĩₜ_{ⱼ}_{+κ|t}_{ⱼ}: =D_{ξ}(\tilde{x}ₜ_{ⱼ}_{+κ|t}_{ⱼ}) is the reconstructed observation from the dynamics prediction for timestep tⱼ+κ. Finally, Ĩₜ_{ⱼ}_{+κ|t}_{ⱼ}:=D_{ξ}(xₜ_{ⱼ}_{+κ}) is the encoded-decoded observation at timestep tⱼ+κ.

It is noted that a multiple-shooting error is for the loss of Equation (8), as the prediction horizon T_{pred} does not need to coincide with the length of the trajectories in the dataset [symbol] . In particular, the loss (8) is computed by sampling a batch of trajectories from [symbol] and then splitting them into N_{dyn} portions of length T_{pred}. The initial timestep of each portion j=1, . . . , N_{dyn} is denoted as tⱼ. The first two terms in the loss function are then penalizing the state and reconstruction error of the multistep predictions of the dynamics model from each initial state xₜ_{ⱼ}. The last term in the loss function penalizes the reconstruction error of the autoencoder directly, without using the dynamics model. Table 1 shows an Evaluation of the collision rate and cumulative filter intervention for a top-down view robotic navigation example and for an egocentric view autonomous driving example.

TABLE 1
Evaluation of the collision rate and cumulative filter intervention (a measure of how intrusive
the filter is with respect to the reference controller) for the top-down view robotic navigation
example (over 20 simulations of 5-seconds each with random initial and goal states) and for the
egocentric view autonomous driving example (over 20 simulations of 50-seconds each with
random initial heading angles). For the BC and ensemble filters, results are provided for 3 different
threshold values: (p_{low}, p_{mid}, p_{high}) = (0.32, 0.35, 0.38) for the navigation example, and
(0.2, 0.5, 0.8) for driving; and (δ_{low}, δ_{mid}, δ_{high}) = (0.0005, 0.001, 0.002) for both examples.

| | | | | BC Filter | | | Ensemble Filter | | |
|---|---|---|---|---|---|---|---|---|---|
| | | π_{ref} | Ours | p_{low} | p_{mid} | p_{high} | δ_{low} | δ_{mid} | δ_{high} |
| Top-Down | Collision | 46.72 ± | 0.28 ± | 35.60 ± | 13.86 ± | 2.48 ± | 43.92 ± | 43.82 ± | 42.88 ± |
| Navigation | Rate (%) | 8.36 | 0.27 | 7.20 | 4.96 | 1.57 | 7.90 | 7.41 | 7.41 |
| | Cumulative | 0.0 ± | 109.2 ± | 85.6 ± | 146.4 ± | 189.1 ± | 150.2 ± | 94.5 ± | 52.7 ± |
| | Intervention | 0.0 | 20.1 | 6.8 | 9.6 | 11.6 | 19.3 | 16.3 | 11.5 |
| Egocentric | Collision | 81.00 ± | 1.56 ± | 21.94 ± | 14.44 ± | 8.78 ± | 78.74 ± | 78.60 ± | 81.50 ± |
| Driving | Rate (%) | 0.23 | 1.20 | 1.85 | 2.69 | 1.86 | 0.20 | 1.63 | 0.27 |
| | Cumulative | 0.0 ± | 278.1 ± | 713.8 ± | 726.7 ± | 750.8 ± | 28.7 ± | 42.8 ± | 208.9 ± |
| | Intervention | 0.0 | 32.6 | 1.4 | 2.6 | 6.9 | 2.1 | 3.6 | 5.7 |

An iDBF can be learned together with the autoencoder and dynamics model by optimizing jointly the losses (7) and (8). For the iDBF loss, each x_{safe} is obtained by encoding the observations sampled from the dataset [symbol] , and x_{unsafe} is obtained by forward propagating the actions that have a low probability according to the pretrained BC model, as explained at the end of last section.

Once the iDBF B_{ϕ} dynamics model f_{θ} and g_{θ}; and encoder E_{ψ} networks are trained, a policy filter construct—which is referred to iDBF-QP in FIG. 6—in an equivalent manner to the CBF-QP that was introduced in Section 3. According to some aspects of the present disclosure, the iDBF training procedure encourages the satisfaction of the CBF conditions (2), (3) and (4) at a discrete set of training points (which have measure zero). The empirical results of Section 5 show that the task-agnostic policy filter control framework 600 takes a promising first step towards building effective policy filters from raw high-dimensional observations.

### 5. EXAMPLES

This section presents the empirical evaluation of the task-agnostic policy filter control framework 600 on two different simulation environments: a toy example of a robot navigation task using top-down images of the scene, and an autonomous driving scenario with egocentric image observations. For both cases, given a safety-agnostic reference controller π_{ref}, the iDBF-QP is used at each timestep with the latest image measurement (e.g., a real-time output) to find the closest control input to π_{ref} among those that prevent the system from entering OOD states (see FIG. 6). For each environment, the iDBF module 620, the autoencoder network 610, and the dynamics model (e.g., independent latent state-space dynamic models (f_{θ} and g_{θ}) generated by the neural ODE module 630) are trained using a dataset containing 64×64 RGB images of offline-collected trajectories.

Robot Navigation with Top-Down View Images

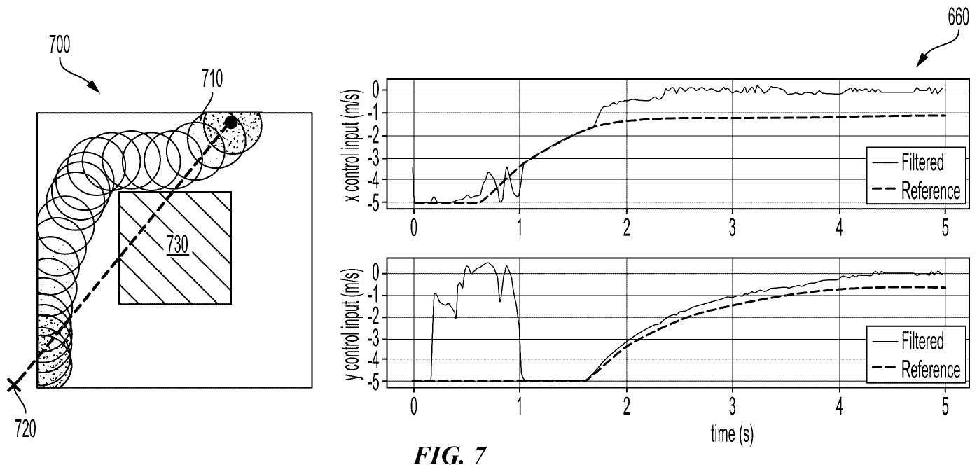

FIG. 7 illustrates diagrams of an example result using the disclosed policy filter for a robot top-down visual navigation task, according to aspects of the present disclosure. In this example, the reference controller simply tries to bring the robot 710 to a goal state 720. In some aspects of the present disclosure, the proposed filter, by keeping the system in-distribution, prevents the robot 710 from colliding against the static obstacle 730 and maintains a center-point of the robot 710 inside the limits of an image 700.

As shown in FIG. 7, the robot 710 is a circular robot with radius of one (1) meter navigating inside of a room (e.g., 10×10 meter) that has a square-shaped meter static obstacle 730 (e.g., 4×4) in the middle, according to aspects of the present disclosure. The underlying dynamics of the robot 710 are those of a 2D single integrator, with two control inputs corresponding to the x and y velocity commands, although having access to that knowledge is not assumed. Instead, a dataset of image-action pairs is provided, which corresponds to five thousand (5000) trajectories of one hundred (100) points each (corresponding to 2 seconds since the time-step is 0.02 s). These trajectories satisfy two requirements: 1) the robot 710 should never collide against the obstacle, and 2) the center of the robot 710 should never leave the room limits. The trajectories are collected by applying random actions at each time-step, and both conditions are checked before adding a trajectory to the dataset.

In some aspects of the present disclosure, the task-agnostic policy filter control framework 600 is used to train an autoencoder with a latent state-space of dimensions, a dynamics model, and an iDBF, for example, as shown in FIG. 6. The reference policy π_{ref} simply applies a velocity in the direction of a goal-point, with magnitude proportional to the distance. FIG. 6, illustrates the results of applying the disclosed iDBF-QP policy filter when the goal state (marked with an ×) is outside of the room limits and at the other side of the obstacle. Even though the reference controller is trying to take the shortest path, which would go through the obstacle, the iDBF-QP prevents the robot from first, colliding with the obstacle, and second, from having its center exit the room limits.

Autonomous Driving with Egocentric View Images:

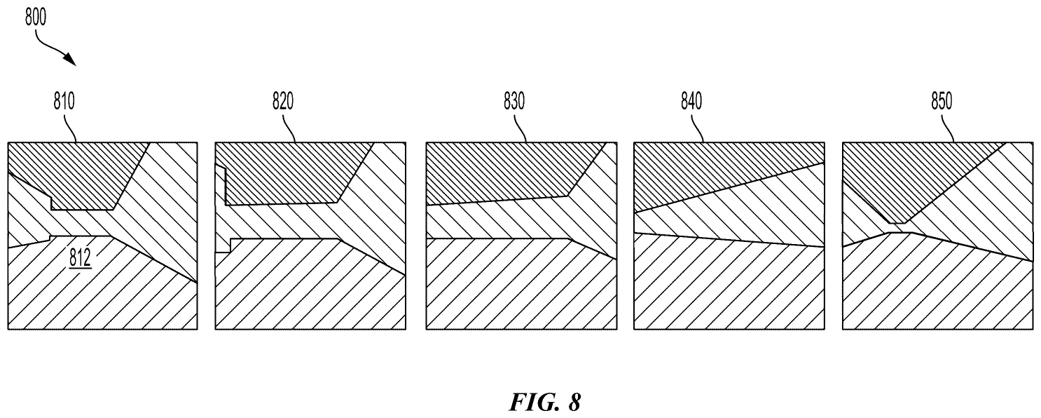

FIG. 8 illustrates snapshots 800 of egocentric view images of a driving simulation when a vehicle is approaching a corner, according to aspects of the present disclosure. In this example, a reference controller commands the vehicle to drive straight; however, the disclosed iDBF-QP policy filter (see FIG. 6) forces a left turn as the vehicle approaches a corner. Therefore, the disclosed policy filter prevents a collision as a result of staying in-distribution with respect to the safe training data.

As shown in FIG. 8, a vehicle navigates in a corridor which has four 90-degree turns to form a square-shaped centerline 812, according to various aspects of the present disclosure. One of such turns is shown in the snapshots of FIG. 8. The vehicle receives two control inputs: a desired forward velocity and a steering angle. Given the high-order dynamics of the simulator, data is manually collected to make sure no trajectories included in the dataset are deemed to collide with any of the walls. In this example, the collected data is split (e.g., into 450 trajectories of 100 points each and 5 seconds since the timestep is 0.05 s). This makes for a much sparser and less diverse dataset compared to the previous example because a human collects the dataset.

During deployment, a reference controller π_{ref} is used that simply drives the vehicle forward at a constant speed of 3.5 m/s. Using, for example, the iDBF-QP policy filter 640 of the task-agnostic policy filter control framework 600 of FIG. 6, and taking the latest egocentric RGB measurement as input, the iDBF-QP policy filter 640 of FIG. 6 is highly effective at preventing the vehicle from colliding against the walls, as shown in Table 1. FIG. 8 contains snapshots 820, 830, 840, and 850 illustrating the iDBF-QP policy filter 640 forcing the vehicle to take a turn as it approaches a corner, even though the reference command is to drive forward.

Using these simulation environments, the proposed approach is compared with other techniques for avoiding distributional shift. In these examples, baselines are built upon a conditional neural behavioral cloning (BC) density model of the training data and an ensemble of latent state-space dynamics models.

### BC Density Filter Baseline

As explained in Section 3, a BC multi-modal Gaussian model is trained to generate the contrastive training distribution for the iDBF. For any state, the BC model outputs a probability distribution over actions, with density function π_{BC}(u|x). This BC model is trained using privileged true-state information of the system and use its density values to build a filter that serves as an apples-to-apples baseline comparison to the proposed approach. Specifically, the baseline also takes the reference controller π_{ref} and, at every timestep, it finds the closest control action to π_{ref}(x) that satisfies π_{BC}(u|x)≥p, out of 200 randomly sampled actions. If no control action satisfying that condition is found, the reference control input is applied without filtering. Given the clear dependence on the threshold value p, this baseline for several values of p is implemented and show the results in Table 1 for three representative cases p_{low}, p_{mid} and p_{high}.

### Ensemble Variance Filter Baseline:

An ensemble of independent latent state-space dynamic models (f_{θ} and g_{θ}) is trained, while keeping the rest of the framework introduced in Section 2 unchanged. During deployment, at every timestep, a search is performed for the closest control action to π_{ref}(x) that keeps the variance σₑₙₛ²(x, u) of the predicted dynamics f_{θ}(x)+g_{θ}(x)u under a threshold δ. As in the previous baseline, this example also searches over 200 randomly sampled actions at each timestep, and different threshold levels δ_{low}, δ_{mid} and δ_{high}. Again, if no control action satisfying the threshold condition is found, the reference control input is applied without filtering.

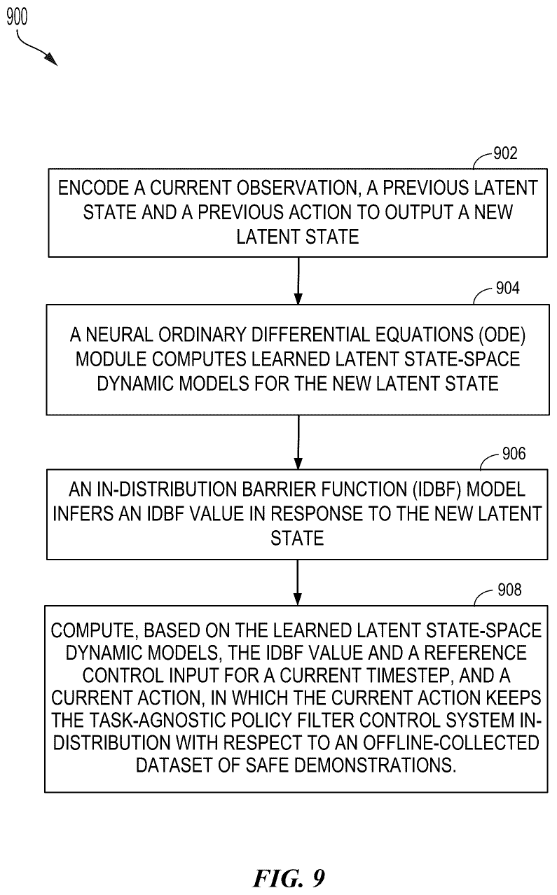

Table 1 provides a summary of the comparison results for both environments. In these examples, the collision rate is used as a proxy for distributional shift since the training data only includes collision-free trajectories. The collision rate for the robot navigation example is computed as the fraction of time that the robot spends either in collision with the obstacle or having its center-point outside of the room limits. For the driving scenario, the collision rate is the fraction of time that the robot is in collision with any of the walls. For both examples, the disclose method drastically reduces the collision rate compared to using the reference (unfiltered) controller. Furthermore, the lowest collision rates are achieved when compared to the baselines. From the baselines, only the BC density filter (with a very restrictive threshold p_{high}) manages to achieve small collision rates, at the cost of an exceedingly high cumulative filter intervention rate. The filter intervention rate is computed for both examples as Σₜ∥uₜ−π_{ref}(xₜ)∥², where each control input dimension is normalized between −1 and 1. A method for a task-agnostic policy filter control system is shown in FIG. 9.

FIG. 9 flowcharts illustrating a method for a task-agnostic policy filter control system, according to aspects of the present disclosure. A method 900 begins at block 902, in which a current observation, a previous latent state, and a previous action are encoded to output a new latent state. For example, as shown in FIG. 3, the recursive encoder module 312 is configured to encode a current observation, a previous latent state, and a previous action to output a new latent state. The inference procedure of an end-to-end learning, task-agnostic policy filter control framework 600 is depicted in FIG. 6. In some aspects of the present disclosure, the task-agnostic policy filter control framework 600 use a recursive, autoencoder network 610 E_{ψ} that takes the current observation I_{κ} 602, as well as the previous latent state 604 (x_{κ-1}) and the previous action 606 (u_{κ-1}) to generate the new latent state space 612x_{κ} at each time-step κ. The decoder network D_{ξ} (see FIG. 5) generates a reconstructed observation Î_{κ} for each latent state x_{κ}.

At block 904, a neural ordinary differential equations (ODE) module computes learned latent state-space dynamic models for the new latent state. For example, as shown in FIG. 3, the neural ODE module 314 is configured to compute learned latent state-space dynamic models for the new latent state. As shown in FIG. 6, given a safety-agnostic reference controller π_{ref}, the iDBF-QP is used at each timestep with the latest image measurement (e.g., a real-time output) to find the closest control input to π_{ref} among those that prevent the system from entering OOD states (see FIG. 6). For each environment, the iDBF module 620, the autoencoder network 610, and the dynamics model (e.g., independent latent state-space dynamic models (f_{θ} and g_{θ}) generated by the neural ODE module 630) are trained using a dataset containing 64×64 RGB images of offline-collected trajectories.

At block 906, an in-distribution barrier function (iDBF) model infers an iDBF value in response to the new latent state. For example, as shown in FIG. 3, The agent controller 310 operates according to the in-distribution barrier function model 316 configured to infer an iDBF value in response to a new latent state from learned latent-space barrier functions based on safe demonstrations. As shown in FIG. 6, during operation of the task-agnostic policy filter control framework 600, at each timestep, based on the current observation I_{κ} 602, the previous latent state 604 and the previous action 606, the autoencoder network 610 E_{ψ} outputs a new latent state x_{κ} 612. Then, the iDBF module 620 generates an iDBF value 622 (B_{θ}(x_{κ}), and the dynamics networks (e.g., a neural ordinary differential equations (ODE) module 630) generate ODE values 632, 634 (e.g., f_{θ}(x_{κ}) and g_{θ}(x_{κ})) which are passed to a iDBF-QP policy filter 640.

At block 908, based on the learned latent state-space dynamic models, the iDBF value and a reference control input are computed for a current timestep, and a current action. The current action keeps the task-agnostic policy filter control system in-distribution with respect to an offline-collected dataset of safe demonstrations. For example, as shown in FIG. 3, the agent action selection module 318 is configured to compute, based on the ODE values, the iDBF value and a reference control input for a current timestep, a current vehicle control action, in which the selected vehicle control action is in-distribution with respect to an offline-collected dataset of safe demonstrations. As shown in FIG. 6, the iDBF-QP policy filter 640 takes a reference control input for the current timestep π_{ref} (x_{κ}) and returns the closest action 642 that keeps the system in-distribution with respect to the offline-collected dataset of safe demonstrations. For both of the examples described below, the total inference time (NN Inference+solving the iDBF-QP) of the task-agnostic policy filter control framework 600 is less than 5 milliseconds.

The method 900 may further include collecting an off-line dataset of safe demonstrations. The method 900 may also include training the iDBF model to learn latent-space barrier functions from the off-line dataset of safe demonstrations. The method 900 further includes acquiring observations and control inputs from a safe dataset derived during training. The method 900 may also include mapping, by a decoder, a latent space to the acquired observations. The method 900 may further include synthetically generating unsafe demonstrations using a pre-trained behavior cloning model for comparisons with true safe demonstrations to enable training using noise-contrastive learning. The method 900 may include computing the independent latent state-space dynamic models by utilizing a neural ordinary differential equation (ODE) that describes learned dynamics in the new latent space based on training the independent latent state-space dynamic models using noise-contrastive learning.

In some aspects of the present disclosure, the method 900 also includes inferring an iDBF value by measuring, using a control barrier function (CBF), a safety score of the new latent space to yield an optimization-based safe controller. The method 900 further includes filtering unsafe inputs using the iDBF model to direct the task-agnostic policy filter control system. The method 900 further includes leveraging offline safe demonstrations from raw sensor observations. The method 900 further includes feeding the offline safe demonstrations into the iDBF model to prevent the task-agnostic policy filter control system from entering unsafe situations at runtime. The method 900 further includes leveraging offline safe demonstrations from raw sensor observations; and feeding a real-time output of a reference policy into the iDBF model to prevent the task-agnostic policy filter control system from entering unsafe situations at runtime.

In some aspects of the present disclosure, the method shown in FIG. 9 may be performed by the SOC 100 (FIG. 1) or the software architecture 200 (FIG. 2) of the autonomous agent 150. That is, each of the elements or methods may, for example, but without limitation, be performed by the SOC 100, the software architecture 200, the processor (e.g., CPU 102), and/or other components included therein of the autonomous agent 150, the task-agnostic policy filter agent control system 300, or the task-agnostic policy filter control framework 600.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in several ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for a task-agnostic policy filter control system, the method comprising:
encoding a current observation, a previous latent state, and a previous action to output a new latent state;
computing, by a neural ordinary differential equations (ODE) module, learned latent state-space dynamic models for the new latent state;
inferring, by an in-distribution barrier function (iDBF) model, an iDBF value in response to the new latent state; and
computing, based on the learned latent state-space dynamic models, the iDBF value and a reference control input for a current timestep, and a current action, in which the current action keeps the task-agnostic policy filter control system in-distribution with respect to an offline-collected dataset of safe demonstrations.

2. The method of claim 1, further comprising:
collecting an off-line dataset of safe demonstrations; and
training the iDBF model to learn latent-space barrier functions from the off-line dataset of safe demonstrations.

3. The method of claim 1, further comprising:
acquiring observations and control inputs from a safe dataset derived during training; and
reconstructing, by a decoder, the acquired observations according to a latent space.

4. The method of claim 1, further comprising synthetically generating unsafe demonstrations using a pre-trained behavior cloning model for comparisons with true safe demonstrations to enable training using noise-contrastive learning.

5. The method of claim 1, in which computing the independent latent state-space dynamic models comprises utilizing a neural ordinary differential equation (ODE) that describes learned dynamics in the new latent state based on training the independent latent state-space dynamic models using noise-contrastive learning.

6. The method of claim 1, in which inferring the iDBF value comprises measuring, using a control barrier function (CBF), a safety score of the new latent state to yield an optimization-based safe controller.

7. The method of claim 1, further comprising filtering unsafe inputs using the iDBF model to direct the task-agnostic policy filter control system.

8. The method of claim 1, further comprising:
leveraging offline safe demonstrations from raw sensor observations; and
feeding a real-time output of a reference policy into the iDBF model to prevent the task-agnostic policy filter control system from entering unsafe situations at runtime.

9. A non-transitory computer-readable medium having program code recorded thereon for a task-agnostic policy filter control system, the program code being executed by a processor and comprising:
program code to encode a current observation, a previous latent state, and a previous action to output a new latent state;
program code to compute, by a neural ordinary differential equations (ODE) module, learned latent state-space dynamic models for the new latent state;
program code to infer, by an in-distribution barrier function (iDBF) model, an iDBF value in response to the new latent state; and
program code to compute, based on the learned latent state-space dynamic models, the iDBF value and a reference control input for a current timestep, and a current action, in which the current action keeps the task-agnostic policy filter control system in-distribution with respect to an offline-collected dataset of safe demonstrations.

10. The non-transitory computer-readable medium of claim 9, further comprising:
program code to collect an off-line dataset of safe demonstrations; and
program code to train the iDBF model to learn latent-space barrier functions from the off-line dataset of safe demonstrations.

11. The non-transitory computer-readable medium of claim 9, further comprising:
program code to acquire observations and control inputs from a safe dataset derived during training; and
program code to reconstruct, by a decoder, the acquired observations according to a latent space.

12. The non-transitory computer-readable medium of claim 9, further comprising program code to synthetically generate unsafe demonstrations using a pre-trained behavior cloning model for comparisons with true safe demonstrations to enable training using noise-contrastive learning.

13. The non-transitory computer-readable medium of claim 9, in which the program code to compute the independent latent state-space dynamic models comprises program code to utilize a neural ordinary differential equation (ODE) that describes learned dynamics in the new latent state based on training the independent latent state-space dynamic models using noise-contrastive learning.

14. The non-transitory computer-readable medium of claim 9, in which the program code to infer the iDBF value comprises program code to measure, using a control barrier function (CBF), a safety score of the new latent state to yield an optimization-based safe controller.

15. The non-transitory computer-readable medium of claim 9, further comprising program code to filter unsafe inputs using the iDBF model to direct the task-agnostic policy filter control system.

16. The non-transitory computer-readable medium of claim 9, further comprising:
program code to leverage offline safe demonstrations from raw sensor observations; and
program code to feed a real-time output of a reference policy into the iDBF model to prevent the task-agnostic policy filter control system from entering unsafe situations at runtime.

17. A task-agnostic policy filter control system, the system comprising:
a recursive encoder module to encode a current observation, a previous latent state, and a previous action to output a new latent state;
a neural ordinary differential equations (ODE) module to compute learned latent state-space dynamic models for the new latent state;
an in-distribution barrier function (iDBF) model to infer an iDBF value in response to the new latent state; and
an agent action selection module to compute, based on the learned latent state-space dynamic models, the iDBF value and a reference control input for a current timestep, and a current action, in which the current action keeps the task-agnostic policy filter control system in-distribution with respect to an offline-collected dataset of safe demonstrations.

18. The system of claim 17, in which the neural ODE module is further to utilize a neural ODE that describes learned dynamics in the new latent state based on training the independent latent state-space dynamic models using noise-contrastive learning.

19. The system of claim 17, in which the iDBF model is further to measure, using a control barrier function (CBF), a safety score of the new latent state to yield an optimization-based safe controller.

20. The system of claim 17, in which the agent action selection module is further to leverage offline safe demonstrations from raw sensor observations, and to feed a real-time output of a reference policy into the iDBF model to prevent the task-agnostic policy filter control system from entering unsafe situations at runtime.
